(19) United States
(12) Patent Application Publication
(10) Pub. No.: US 2016/0078161 A1
(43) Pub. Date: Mar. 17, 2016

(54) Structural Topology Optimization Using Numerical Derivatives

(71) Applicant: Livermore Software Technology Corporation, Livermore, CA (US)

(72) Inventor: Willem J. Roux, Livermore, CA (US)

(21) Appl. No.: 14/483,444

(22) Filed: Sep. 11, 2014

(51) Int. Cl. G06F 17/50

(52) U.S. Cl. CPC G06F 17/5018; G06F 17/5095

(57) ABSTRACT

Definition of a product's design domain along with design objective, at least one target design constraint, macro and field design variables are received in a computer system. Macro design variable is related to the product's design specification while field design variables control the material distribution within the design domain. Candidate design, represented by corresponding FEA model, based on the design domain is established. At least one variation of the candidate design is created by varying macro design variable. Corresponding design constraint of the candidate design and at least one variation are computed via FEA. Trend of the computed design constraints with respect to macro design variable is determined by multi-dimensional data fitting. Macro variables are updated according to the trend. New candidate design is created by computing field design variables using FEA results from the previous candidate design and design specifications including updated values of the macro design variables.

### FIELD

The present invention generally relates to computer aided engineering design, more particularly to improved methods and systems for performing structural topology design optimization of a product.

### BACKGROUND

Today, computer aided engineering (CAE) has been used for supporting engineers in tasks such as analysis, simulation, design, manufacture, etc. In a conventional engineering design procedure, CAE analysis (e.g., finite element analysis (FEA), finite difference analysis, meshless analysis, computational fluid dynamics (CFD) analysis, modal analysis for reducing noise-vibration-harshness (NVH), etc.) has been employed to evaluate responses (e.g., stresses, displacements, etc.). Using automobile design as an example, a particular version or design of a car is analyzed using FEA to obtain the responses due to certain loading conditions. Engineers will then try to improve the car design by modifying certain parameters or design variables (e.g., thickness of the steel shell, locations of the frames, etc.) based on specific objectives and constraints. Another FEA is conducted to reflect these changes until a “best” design has been achieved. However, this approach generally depends on knowledge of the engineers or based on a trial-and-error method. To solve this problem, a systematic approach (referred to as design optimization) to identify the “best” design is used.

Traditionally, design optimization is performed with a computer system and generally divided into three categories, sizing, shape and topology. Structural topology design optimization is best suited for creating optimal conceptual design in which the user (i.e., engineer, designer, etc.) does not have put too many constraints as to the shape and/or size of the engineering product. However, there are problems associated with structural topology design optimization especially for the topology design optimization of a component of a complex structure (e.g., automobile, airplane, etc.). Non-linear structure responses (e.g., design constraints) of the complex product make the progress of the structural topology design optimization difficult to predict. In particular, at each stage of the topology design optimization, the new candidate design is computed using some arbitrary or ad hoc formula for the relationship between the constraints and design variables. As a result, the structural topology optimization procedure can fail or can be overly expensive.

Therefore, it would be desirable to have improved methods and systems for performing structural topology design optimization for an engineering product.

### BRIEF SUMMARY

This section is for the purpose of summarizing some aspects of the present invention and to briefly introduce some preferred embodiments. Simplifications or omissions in this section as well as in the abstract and the title herein may be made to avoid obscuring the purpose of the section. Such simplifications or omissions are not intended to limit the scope of the present invention.

The present invention discloses methods and systems for performing structural topology design optimization of a product. According to one aspect, a definition of the product's design domain along with a design objective, at least one target design constraint, at least one macro design variable and a plurality of field design variables are received in a computer system having one or more application modules installed thereon. The macro design variable is related to the product's design specification while the field design variables control the material distribution within the design domain. A candidate design based on the design domain is initially established. The candidate design is represented by a finite element analysis (FEA) model that contains a plurality of finite elements. Each finite element is associated with one of the field design variables. At least one design constraint of the candidate design is computed via finite element analysis using the corresponding FEA model. At least one variation of the candidate design is created by varying each of the at least one macro variable with a predetermined percentage. Corresponding at least one design constraint of the variation are computed via FEA. A trend of the computed design constraints with respect to at least one macro design variable is determined by a multi-dimensional data fitting scheme. Macro variables are updated according to the trend. A new candidate design is created by computing the field design variables using FEA results from the previous candidate design and design specifications including updated values of the macro design variables. The process continues until the new candidate design converges with the immediately previous candidate design.

### BRIEF DESCRIPTION OF THE DRAWINGS

These and other features, aspects, and advantages of the present invention will be better understood with regard to the following description, appended claims, and accompanying drawings as follows:

FIG. 1 is a flowchart illustrating an example process of conducting structural topology design optimization of a product in accordance with one embodiment of the present invention;

FIGS. 2A, 2B and 2C show example domains with two different example macro design variables in accordance with one embodiment of the present invention;

FIG. 3 is a diagram illustrating a series of candidate design of a product in a structural topology design optimization, according to an embodiment of the present invention;

FIGS. 4A-4C are diagrams showing variations of a candidate design in a structural topology design optimization, according to an embodiment of the present invention;

FIGS. 5A-5C are diagrams showing finite element analysis models representing the variations of the candidate design in a structural topology design optimization, according to an embodiment of the present invention; and

FIG. 6 is a function diagram showing salient components of a computing device, in which an embodiment of the present invention may be implemented.

### DETAILED DESCRIPTION

In the following description, numerous specific details are set forth in order to provide a thorough understanding of the present invention. However, it will become obvious to those skilled in the art that the present invention may be practiced without these specific details. The descriptions and representations herein are the common means used by those experienced or skilled in the art to most effectively convey the substance of their work to others skilled in the art. In other instances, well-known methods, procedures, and components have not been described in detail to avoid unnecessarily obscuring aspects of the present invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Additionally, the term “optimal design” in this document is intended to indicate a design that meets the design requirements (e.g., goal, objective and constraints) in an iterative optimization design process. Furthermore, the terms “optimal configuration”, “optimal design”, “substantially improved design”, “significantly improved design” and “final design” are used interchangeably throughout this document. Finally, the order of blocks in process flowcharts or diagrams representing one or more embodiments of the invention do not inherently indicate any particular order nor imply any limitations in the invention.

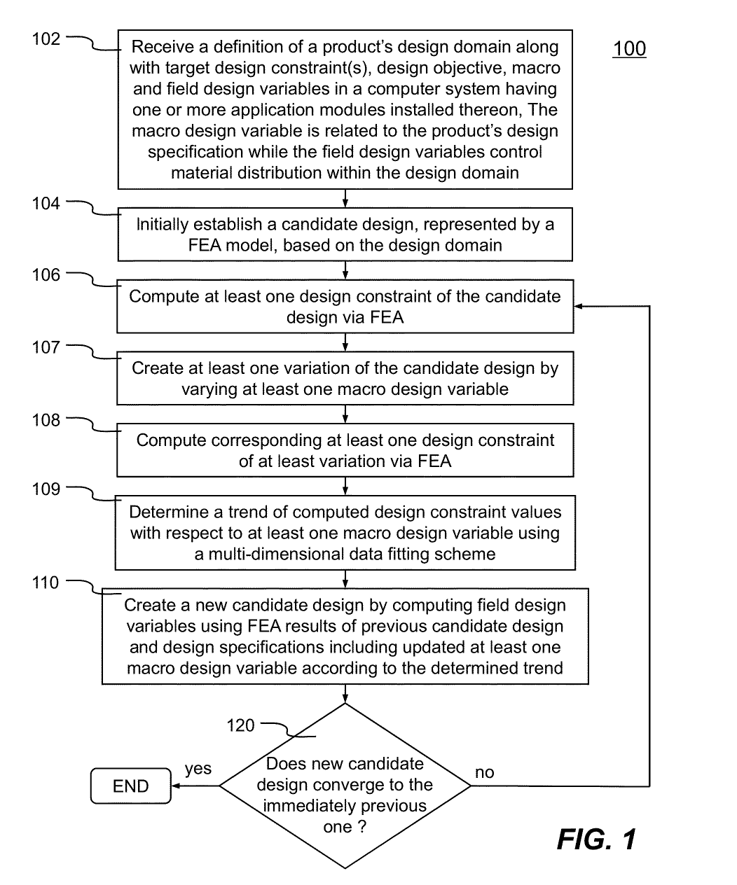

Embodiments of the present invention are discussed herein with reference to FIGS. 1-6. However, those skilled in the art will readily appreciate that the detailed description given herein with respect to these figures is for explanatory purposes as the invention extends beyond these limited embodiments.

Referring first of FIG. 1, it is shown a flowchart illustrating an example process 100 of conducting structural topology design optimization of a product. Process 100 is preferably implemented in software.

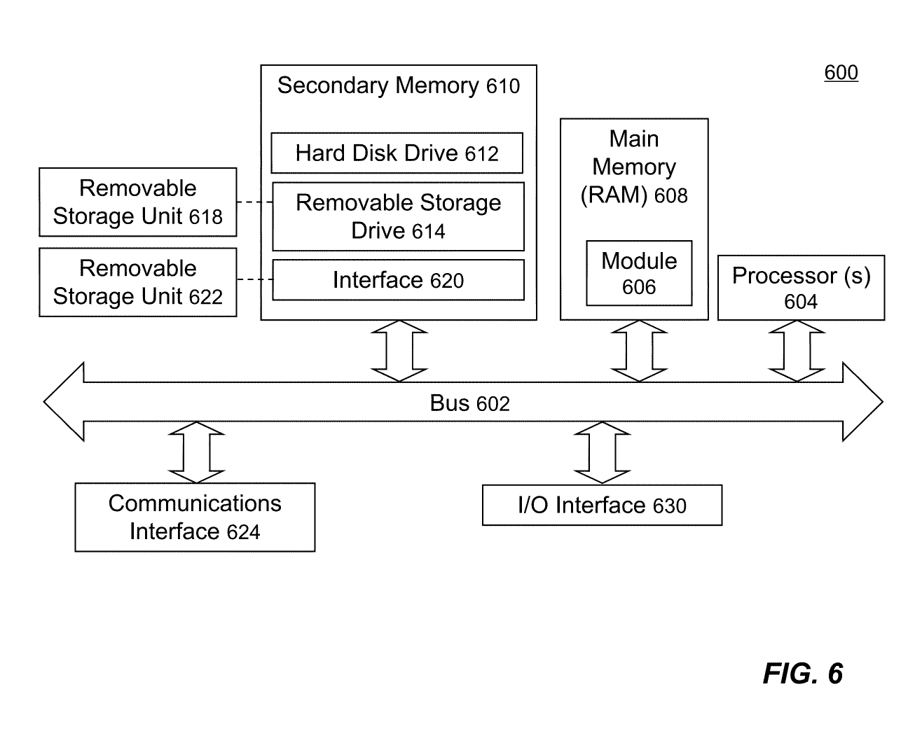

Process 100 starts, at action 102, by receiving a definition of a product's design domain along with at least one target design constraint, design objective, at least one macro design variable and a number of field design variables in a computer system (e.g., computer 600 of FIG. 6) having one or more application modules (e.g., finite element analysis (FEA) application module, topology design optimization application module, etc.) installed thereon. Macro design variable is related to design specification of the product, while field design variables control the material distribution within the design domain. Macro design variable may include, but is not limited to, total mass of the product, weighting factor of each load cases for designing the product.

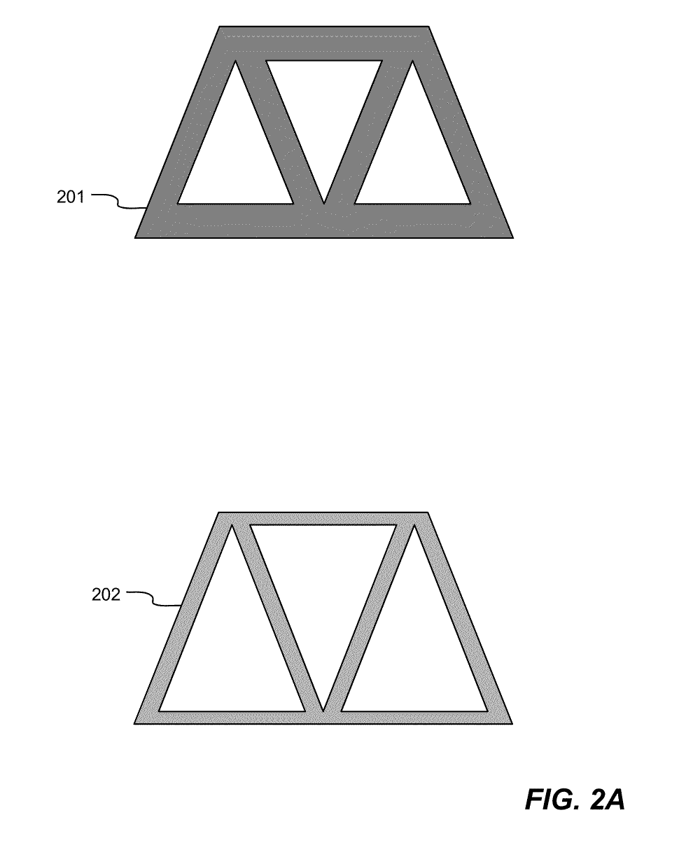

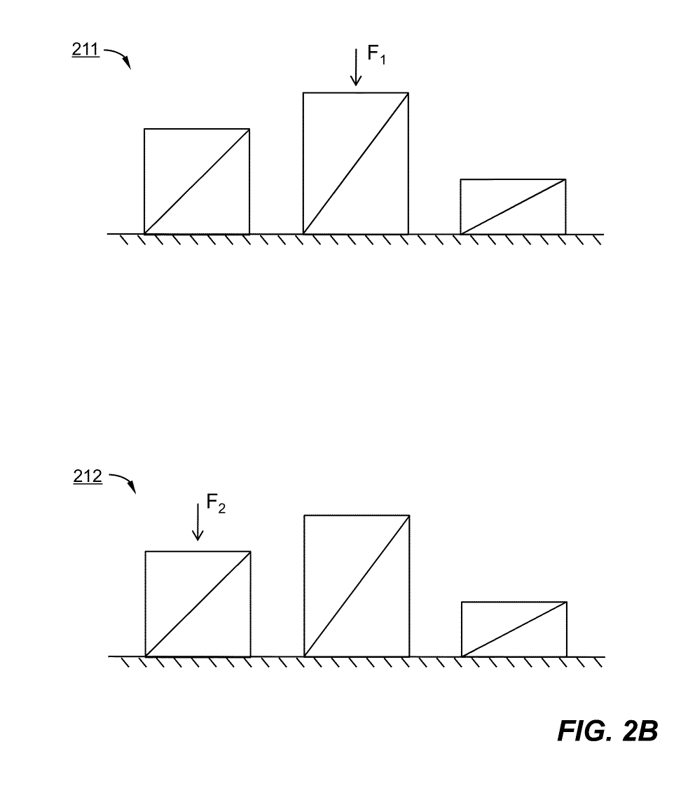

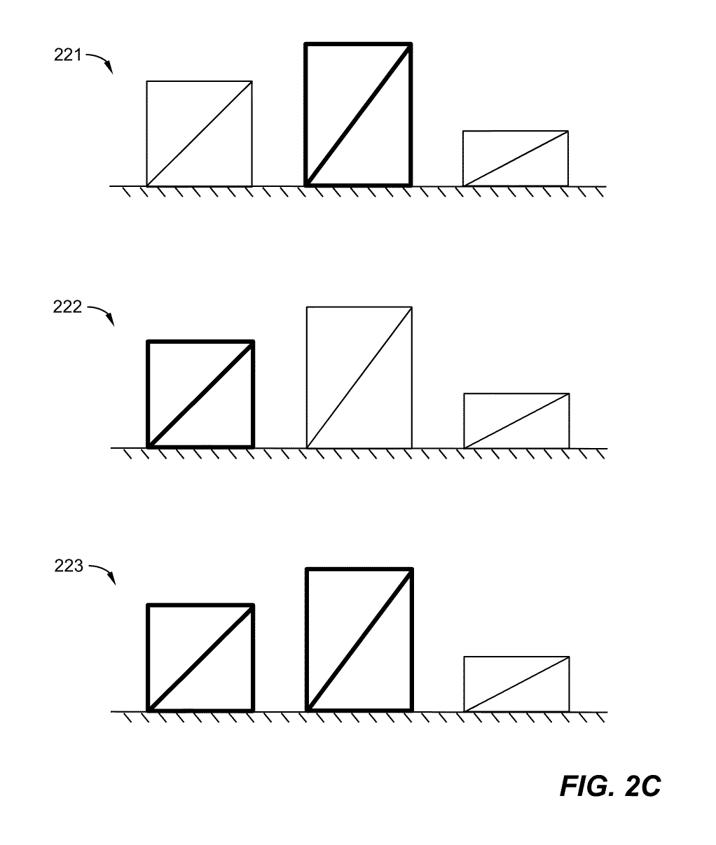

Two example designs 201-202 of a product having similar structure with different mass are shown in FIG. 2A. FIGS. 2B-2C shows an example related to weighting factors of different load cases. The first load case (LC1) 211 has a force F₁ acted at the center while the second load case (LC2) 212 has a force F₂ acted on the left side. FIG. 2C shows three resulting structures with different weighting factors of LC1 and LC2. The first resulting structure 221 is based on higher weighting factor of LC1. The second resulting structure 222 is based on higher weighting factor of LC2. As a result of equally weighted LC1 and LC2, the third structure 223 is shown. At least two macro design variables are required for the weighting factor example.

Field design variables describe the topology or layout of the structure of the product. As such the computation of the field design variables in every iteration is a core computation in topology optimization. Various method of computing the field variables have been used, for example, mathematical programming, hybrid cellular algorithms, evolutionary topology optimization, and optimality criteria. In these methods, the field design variables of the current iteration is computed using the FE analysis results obtained from the previous iteration(s) and considering the design specifications such as the part's mass, load case weighting factors, constraints and objectives.

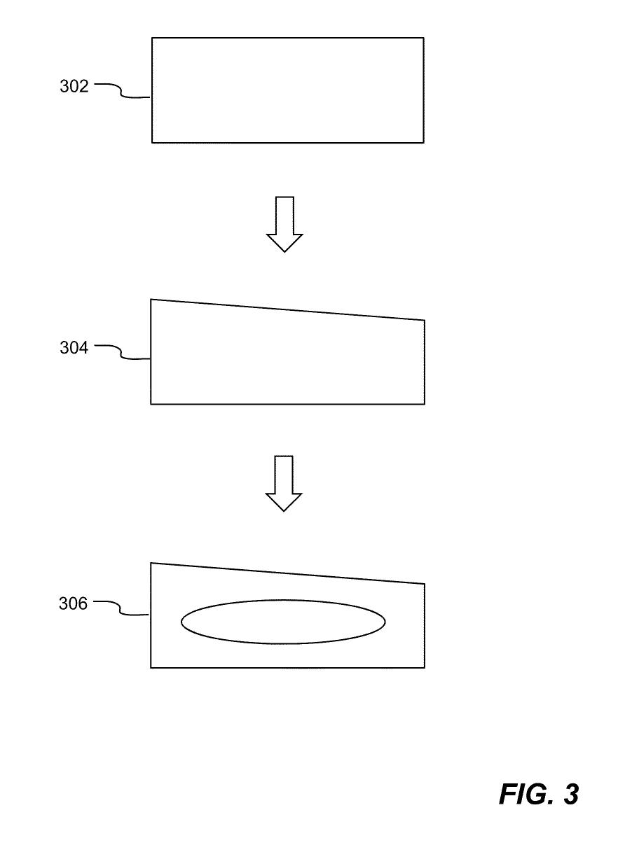

FIG. 3 is a series of diagrams showing various stages of an example product under a structural topology design optimization. Example product's initial design domain is generally an initial configuration received. For illustration simplicity, in this example, the initial configuration or initial candidate design 302 is shown a rectangle 302. After a few iterations or stages of the topology design optimization, an intermediate configuration or candidate design 304 is shown as a trapezoid. Finally, after several more iterations of the optimization, a final configuration 306 is a trapezoid with a hole in the middle. Determination of the final configuration may be achieved with predetermined criteria, for example, the final configuration converges with the immediate previous one, the final configuration is a result after a predefined number (e.g., 5, 10, 20, . . . , etc.) of iterations of the optimization, etc.

For a complex product (e.g., an automobile, airplane) having nonlinear structural behaviors in an impact event, it is difficult to alter the configuration or candidate design between iterations of the optimization such that the new configuration or candidate design would produce a better response towards the at least one target design constraint.

Referring back to process 100, at action 104, an initial candidate design is established. The candidate design is represented by a FEA model which contains nodal points connected by finite elements. According to one embodiment, the amount of material in each finite element is controlled by respective field design variables. In other words, each field design variable is associated with a unique finite element to control amount of material therein. The field design variable has a range between 0 and 1. When the field design variable is 0 (may set to zero when it is within a tolerance for practical and efficient computations), the corresponding finite element is removed from the FEA model.

At action 106, at least one design constraint of the candidate design is computed using the corresponding FEA model by a FEA application module installed in the computer system. In other words, a numerical simulation of the product in the configuration of the candidate design is performed to obtain at least one design constraint (e.g., a displacement at certain location of the product). In FEA of the candidate design, structural responses other than the design constraint are obtained. However, design constraint is used for the trend calculation described below in action 108. Computed design constraint can be higher or lower than the corresponding target design constraint. The objective or goal of the structural topology optimization is to obtain a configuration that satisfies the at least one target design constraint and other design objectives and specifications.

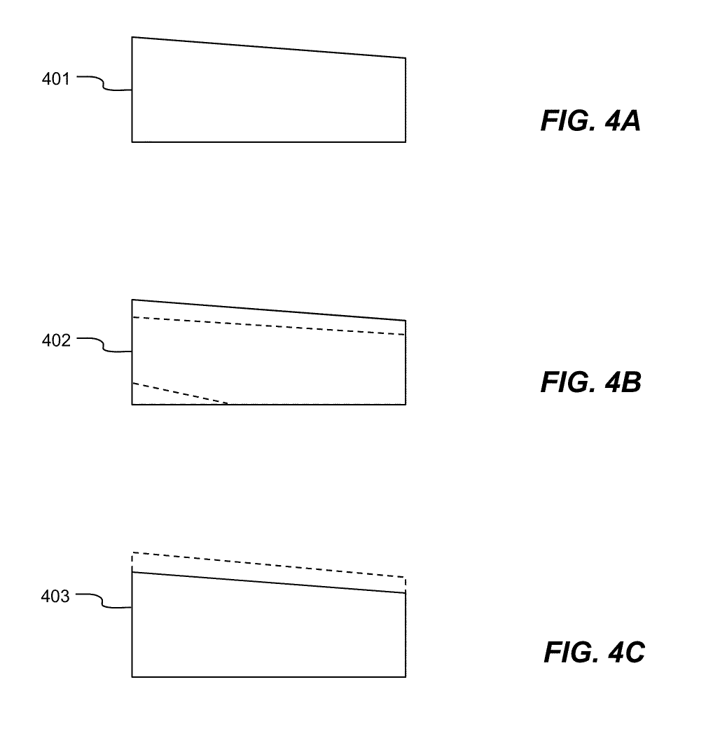

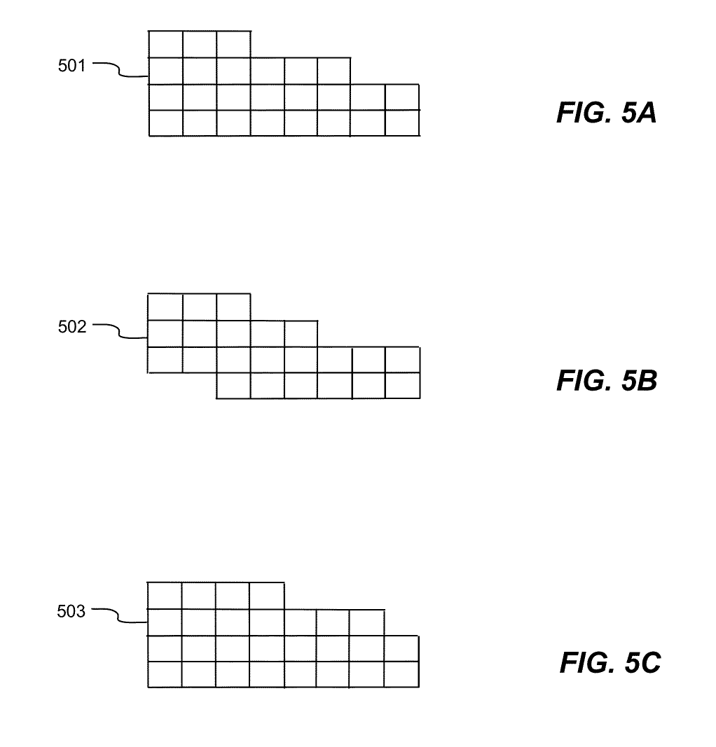

At action 107, at least one variation of the candidate design is created by varying each macro design variable with a predetermined percentage (e.g., 1-10 percent of the macro design variable). Since computed design constraints can be nonlinear, more than one variation may be needed to find out the trend. FIG. 4A shows an example basic candidate design 401. Two different example variations 402-403 are shown in FIGS. 4B-4C. The first variation 402 is slightly smaller than the basic candidate design 401, while the second variation 403 is slightly larger. Corresponding example FEA models 501-503 are shown in FIGS. 5A-5C, respectively. In another embodiment, the variation can be achieved by incrementing or decrementing the field design variables by a small amount (e.g., a predefined percentage). The variation of the part's mass can be computed from the variation of the field design variables.

Next, at action 108, corresponding design constraints of the at least one variation are computed via FEA. A trend of the computed design constraints with respect to the at least one macro design variable is determined using a multi-dimensional data fitting scheme at action 109. In other words, the trend is within a multi-dimensional data space defined by multiple design constraints versus multiple macro design variables. The multi-dimensional data fitting scheme may include, but is not limited to, metamodel (e.g., response surface), finite differences, etc.

Based on the just-determined trend, a new candidate design is selected at action 110. The new candidate design chosen in such manner that can facilitate a faster path to achieve the design objectives and specifications under the at least one target design constraint. In one embodiment, macro design variables are updated according to the determined trend. A new candidate design formed by the field design variables is then computed using the FEA results obtained from the previous candidate design and design specifications that includes the updated values of the macro design variables.

Process 100 moves to decision 120, in which it is determined whether the new candidate design has converged to the immediate previous candidate design. If not, process 100 following the “no” branch to repeat actions 106-100 until the decision 120 becomes true. Process 100 ends thereafter. There are plenty of other well known procedures/techniques/methods to determine as to termination of a structural topology design optimization. Decision 120 is one of the examples. In one embodiment, convergence of current and previous candidate designs can be determined by checking whether there is any appreciable improvement (e.g., within a predefined percentage) from the previous candidate design to the current one.

According to one aspect, the present invention is directed towards one or more computer systems capable of carrying out the functionality described herein. An example of a computer system 600 is shown in FIG. 6. The computer system 600 includes one or more processors, such as processor 604. The processor 604 is connected to a computer system internal communication bus 602. Various software embodiments are described in terms of this exemplary computer system. After reading this description, it will become apparent to a person skilled in the relevant art(s) how to implement the invention using other computer systems and/or computer architectures.

Computer system 600 also includes a main memory 608, preferably random access memory (RAM), and may also include a secondary memory 610. The secondary memory 610 may include, for example, one or more hard disk drives 612 and/or one or more removable storage drives 614, representing a floppy disk drive, a magnetic tape drive, an optical disk drive, etc. The removable storage drive 614 reads from and/or writes to a removable storage unit 618 in a well-known manner. Removable storage unit 618, represents a floppy disk, magnetic tape, optical disk, etc. which is read by and written to by removable storage drive 614. As will be appreciated, the removable storage unit 618 includes a computer usable storage medium having stored therein computer software and/or data.

In alternative embodiments, secondary memory 610 may include other similar means for allowing computer programs or other instructions to be loaded into computer system 600. Such means may include, for example, a removable storage unit 622 and an interface 620. Examples of such may include a program cartridge and cartridge interface (such as that found in video game devices), a removable memory chip (such as an Erasable Programmable Read-Only Memory (EPROM), Universal Serial Bus (USB) flash memory, or PROM) and associated socket, and other removable storage units 622 and interfaces 620 which allow software and data to be transferred from the removable storage unit 622 to computer system 600. In general, Computer system 600 is controlled and coordinated by operating system (OS) software, which performs tasks such as process scheduling, memory management, networking and I/O services.

There may also be a communications interface 624 connecting to the bus 602. Communications interface 624 allows software and data to be transferred between computer system 600 and external devices. Examples of communications interface 624 may include a modem, a network interface (such as an Ethernet card), a communications port, a Personal Computer Memory Card International Association (PCMCIA) slot and card, etc. The computer 600 communicates with other computing devices over a data network based on a special set of rules (i.e., a protocol). One of the common protocols is TCP/IP (Transmission Control Protocol/Internet Protocol) commonly used in the Internet. In general, the communication interface 624 manages the assembling of a data file into smaller packets that are transmitted over the data network or reassembles received packets into the original data file. In addition, the communication interface 624 handles the address part of each packet so that it gets to the right destination or intercepts packets destined for the computer 600. In this document, the terms “computer program medium” and “computer usable medium” are used to generally refer to media such as removable storage drive 614, and/or a hard disk installed in hard disk drive 612. These computer program products are means for providing software to computer system 600. The invention is directed to such computer program products.

The computer system 600 may also include an input/output (I/O) interface 630, which provides the computer system 600 to access monitor, keyboard, mouse, printer, scanner, plotter, and alike.

Computer programs (also called computer control logic) are stored as application modules 606 in main memory 608 and/or secondary memory 610. Computer programs may also be received via communications interface 624. Such computer programs, when executed, enable the computer system 600 to perform the features of the present invention as discussed herein. In particular, the computer programs, when executed, enable the processor 604 to perform features of the present invention. Accordingly, such computer programs represent controllers of the computer system 600.

In an embodiment where the invention is implemented using software, the software may be stored in a computer program product and loaded into computer system 600 using removable storage drive 614, hard drive 612, or communications interface 624. The application module 606, when executed by the processor 604, causes the processor 604 to perform the functions of the invention as described herein.

The main memory 608 may be loaded with one or more application modules 606 that can be executed by one or more processors 604 with or without a user input through the I/O interface 630 to achieve desired tasks. In operation, when at least one processor 604 executes one of the application modules 606, the results are computed and stored in the secondary memory 610 (i.e., hard disk drive 612). The status of the CAE analysis or design optimization (e.g., candidate design at each iteration) is reported to the user via the I/O interface 630 either in a text or in a graphical representation.

Although the present invention has been described with reference to specific embodiments thereof, these embodiments are merely illustrative, and not restrictive of, the present invention. Various modifications or changes to the specifically disclosed exemplary embodiments will be suggested to persons skilled in the art. For example, whereas the example domain and product have been shown as two-dimensional objects/items/products, the present invention does not set such limit, three-dimensional objects/items/products can be created using the structural topology design optimization disclosed herein. In summary, the scope of the invention should not be restricted to the specific exemplary embodiments disclosed herein, and all modifications that are readily suggested to those of ordinary skill in the art should be included within the spirit and purview of this application and scope of the appended claims.

I claim:

1. A method of conducting structural topology design optimization of a product comprising:
(a) receiving, in a computer system having one or more application modules installed thereon, a definition of the product's design domain along with a design objective, at least one target design constraint, at least one macro design variable and a plurality of field design variables, said at least one macro design variable being related to the product's design specification while said field design variables controlling material distribution within the design domain;
(b) initially establishing a candidate design based on the design domain, the candidate design being represented by a finite element analysis (FEA) model containing a plurality of finite elements each associated with one of said field design variables;
(c) computing, by said one or more application module, at least one design constraint of said candidate design via FEA;
(d) creating, by said one or more application module, at least one variation of the candidate design by varying the at least one macro design variable with a predefined percentage;
(e) computing, by said one or more application module, corresponding at least one design constraint of the at least one variation via FEA;
(f) determining, by said one or more application module, a trend of the computed design constraints with respect to each of the at least one macro design variable using a multi-dimensional data fitting scheme;
(g) updating, by said one or more application module, the at least one macro design variable according to the determined trend;
(h) creating, by said one or more application module, a new candidate design by computing corresponding values of the field design variables using results obtained from the FEA of an immediately previous candidate design and the updated at least one macro design variable; and
(i) repeating (c)-(h) until the new candidate design converges with the immediately previous candidate design.

2. The method of claim 1, wherein said at least one macro design variable comprises the product's total mass.

3. The method of claim 1, wherein said at least one variation is achieved by incrementing or decrementing the field design variables by a predefined percentage.

4. The method of claim 1, wherein said at least one variation is further achieved by computing corresponding field design variables according to said varying of the at least one macro design variable.

5. The method of claim 1, wherein said predetermined percentage has a range between one to ten percents.

6. The method of claim 1, wherein said plurality of field design variables comprises said each finite element's mass density.

7. The method of claim 1, wherein the multi-dimensional data fitting scheme comprises metamodels.

8. The method of claim 1, wherein the multi-dimensional data fitting scheme comprises finite differences.

9. A system for conducting structural topology design optimization of a product comprising:
a main memory for storing computer readable code for one or more application modules;
at least one processor coupled to the main memory, said at least one processor executing the computer readable code in the main memory to cause said one or more application modules to perform operations by a method of:
(a) receiving a definition of the product's design domain along with a design objective, at least one target design constraint, at least one macro design variable and a plurality of field design variables, said at least one macro design variable being related to the product's design specification while said field design variables controlling material distribution within the design domain;
(b) initially establishing a candidate design based on the design domain, the candidate design being represented by a finite element analysis (FEA) model containing a plurality of finite elements each associated with one of said field design variables;
(c) computing at least one design constraint of said candidate design via FEA;
(d) creating at least one variation of the candidate design by varying the at least one macro design variable with a predefined percentage;
(e) computing corresponding at least one design constraint of the at least one variation via FEA;
(f) determining a trend of the computed design constraints with respect to each of the at least one macro design variable using a multi-dimensional data fitting scheme;
(g) updating the at least one macro design variable according to the determined trend;
(h) creating a new candidate design by computing corresponding values of the field design variables using results obtained from the FEA of an immediately previous candidate design and the updated at least one macro design variable; and
(i) repeating (c)-(h) until the new candidate design converges with the immediately previous candidate design.

10. The system of claim 9, wherein said at least one macro design variable comprises the product's total mass.

11. The system of claim 9, wherein said at least one variation is achieved by incrementing or decrementing the field design variables by a predefined percentage.

12. The system of claim 9, wherein said at least one variation is further achieved by computing corresponding field design variables according to said varying of the macro design variable.

13. The system of claim 9, wherein said predetermined percentage has a range between one to ten percents.

14. The system of claim 9, wherein said plurality of field design variables comprises said each finite element's mass density.

15. A non-transitory computer-readable storage medium containing instructions for conducting structural topology design optimization of a product by a method comprising:
(a) receiving, in a computer system having one or more application modules installed thereon, a definition of the product's design domain along with a design objective, at least one target design constraint, at least one macro design variable and a plurality of field design variables, said at least one macro design variable being related to the product's design specification while said field design variables controlling material distribution within the design domain;
(b) initially establishing a candidate design based on the design domain, the candidate design being represented by a finite element analysis (FEA) model containing a plurality of finite elements each associated with one of said field design variables;
(c) computing, by said one or more application module, at least one design constraint of said candidate design via FEA;
(d) creating, by said one or more application module, at least one variation of the candidate design by varying the at least one macro design variable with a predefined percentage;
(e) computing, by said one or more application module, corresponding at least one design constraint of the at least one variation via FEA;
(f) determining, by said one or more application module, a trend of the computed design constraints with respect to each of the at least one macro design variable using a multi-dimensional data fitting scheme;
(g) updating, by said one or more application module, the at least one macro design variable according to the determined trend;
(h) creating, by said one or more application module, a new candidate design by computing corresponding values of the field design variables using results obtained from the FEA of an immediately previous candidate design and the updated at least one macro design variable; and
(i) repeating (c)-(h) until the new candidate design converges with the immediately previous candidate design.

16. The non-transitory computer-readable storage medium of claim 15, wherein said at least one macro design variable comprises the product's total mass.

17. The non-transitory computer-readable storage medium of claim 15, wherein said at least one variation is achieved by incrementing or decrementing the field design variables by a predefined percentage.

18. The non-transitory computer-readable storage medium of claim 15, wherein said at least one variation is further achieved by computing corresponding field design variables according to said varying of the macro design variable.

19. The non-transitory computer-readable storage medium of claim 15, wherein said predetermined percentage has a range between one to ten percents.

20. The non-transitory computer-readable storage medium of claim 15, wherein said plurality of field design variables comprises said each finite element's mass density.
